(19) United States
(12) Patent Application Publication
(10) Pub. No.: US 2013/0314371 A1
(43) Pub. Date: Nov. 28, 2013

(54) In-Cell Touch Display Panel Structure with Metal Layer for Sensing

(71) Applicant: SuperC-Touch Corporation, New Taipei City (TW)

(72) Inventor: Hsiang-Yu LEE, New Taipei City (TW)

(73) Assignee: SuperC-Touch Corporation, New Taipei City (TW)

(21) Appl. No.: 13/891,897

(22) Filed: May 10, 2013

(30) Foreign Application Priority Data
May 22, 2012 (TW) 101209658

(51) Int. Cl. G06F 3/041

(52) U.S. Cl. CPC G06F 3/0412
USPC 345/174

(57) ABSTRACT

An in-cell touch display panel structure with metal layer for sensing includes a first substrate, a second substrate, a liquid crystal layer, a black matrix layer and a sensing electrode layer. The first substrate and the second substrate are in parallel with each other and the liquid crystal layer is configured between the first substrate and the second substrates. The black matrix layer is composed of a plurality of opaque lines. The sensing electrode layer is disposed at one surface of the black matrix layer facing the liquid crystal layer. The sensing electrode layer is composed of a plurality of sensing conductive lines. The plurality of sensing conductive lines is disposed corresponding to positions of the plurality of opaque lines of the black matrix.

### BACKGROUND OF THE INVENTION

1. Field of the Invention

The present invention discloses a structure of touch display panel and, more particularly, an in-cell touch display panel structure with metal layer for sensing.

2. Description of Related Art

A conventional touch display panel includes a touch panel and a display unit overlapped with the touch panel. The touch panel is configured as an operation interface. The touch panel is transparent so that an image generated by the display unit can be viewed directly by a user without being sheltered by the touch panel. Such well known skill of the touch panel may increase additional weight and thickness of the touch display panel, and may further reduce the light penetration rate, and increase reflectance and haze of the touch display panel.

On-cell and in-cell touch technology were invented to overcome the drawbacks of traditional touch technology described above. The on-cell technology is to dispose a sensor on the back side of a color filter substrate to form a completed color filter substrate. One of the on-cell touch technologies is provided to dispose a touch sensor on a thin film and then bond the thin film onto the upper one of the two substrates.

The in-cell technology is to dispose the sensor within the LCD cell structure. Currently, there are resistive, capacitive and optical three primary in-cell touch technologies, wherein the resistive touch technology employs two conductive substrates and the voltage variation of a common layer between the two substrates for determining a touch position on the touch display panel.

The in-cell touch technology is provided to integrate the touch sensor within the display unit so that the display unit is provided with the ability of the touch panel. Therefore, the touch display panel does not need to be bonded with an additional touch panel so as to simplify the assembly procedure. Such skill is generally developed by TFT LCD manufactures.

There is older touch control technology known as out-cell, which is typically applied to the resistive and capacitive touch panels. The out-cell touch technology is provided to add a touch module onto a display module. The touch module and the display module can be manufactured by the two separated parties.

However, for all the in-cell, on-cell and out-cell touch technologies, they all need a sensing layer to be configured on an upper or lower glass substrate, which not only increases the manufacturing cost but also complicates the manufacturing process, and which may also lower the aspect ratio and thus increase the strength of backlight, resulting in huge power consumption which is disadvantageous to make the mobile device compact. Therefore, it desired for the aforementioned touch display panel structure to be improved.

### SUMMARY OF THE INVENTION

The object of the present invention is to provide an in-cell touch display panel structure with metal layer for sensing, which greatly decreases the weight and thickness of a TFT touch LCD panel and also significantly reduces the material and manufacturing cost.

To achieve the object, there is provided an in-cell touch display panel structure with metal layer for sensing, which includes: a first substrate; a second substrate parallel to the first substrate; a liquid crystal layer configured between the first substrate and the second substrates; a black matrix layer disposed at one surface of the first substrate facing the liquid crystal layer, the black matrix layer being composed of a plurality of opaque lines; and a sensing electrode layer disposed at one surface of the black matrix layer facing the liquid crystal layer, the sensing electrode layer being composed of a plurality of sensing conductive lines, wherein the plurality of sensing conductive lines are disposed corresponding to positions of the plurality of opaque lines of the black matrix.

Other objects, advantages, and novel features of the invention will become more apparent from the following detailed description when taken in conjunction with the accompanying drawings.

### BRIEF DESCRIPTION OF THE DRAWINGS

FIG. 1 shows an in-cell touch display panel structure with metal layer for sensing in accordance with a preferred embodiment of the present invention;

FIG. 2 shows a prior black matrix layer;

FIG. 3 is a schematic diagram of the sensing electrode layer in accordance with the present invention; and

FIG. 4 is a schematic diagram of the black matrix layer and the sensing electrode layer in accordance with the present invention.

### DETAILED DESCRIPTION OF THE PREFERRED EMBODIMENT

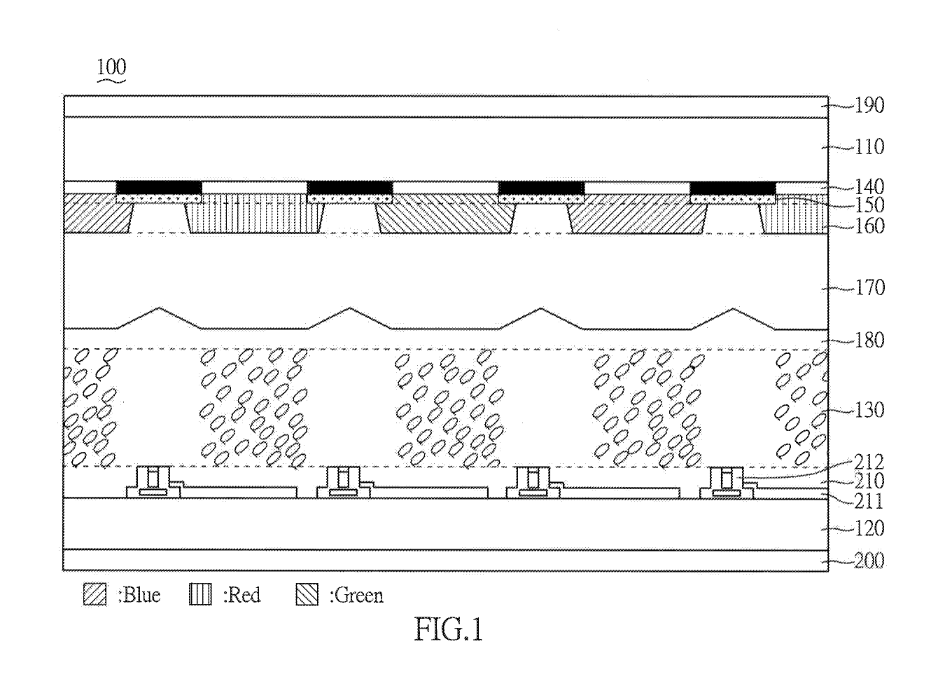

As shown in FIG. 1, there is shown an in-cell touch display panel structure with metal layer for sensing 100 in accordance with a preferred embodiment of the present invention. The in-cell touch display panel structure with metal layer for sensing 100 includes a first substrate 110, a second substrate 120, a liquid crystal layer 130, a black matrix layer 140, a sensing electrode layer 150, a color filter layer 160, an over coating layer 170, a common electrode (Vcom) layer 180, a first polarizer layer 190, a second polarizer layer 200, and a thin film transistor (TFT) layer 210.

The first substrate 110 and the second substrate 120 are preferably glass substrates and are parallel to each other. The liquid crystal layer 130 is disposed between the first and second substrates 110, 120.

The black matrix layer 140 is between substrate 110 and liquid crystal layer 130 and is disposed at one surface of the first substrate 110 that faces the liquid crystal layer 130. The black matrix layer 140 is composed of a plurality of opaque lines.

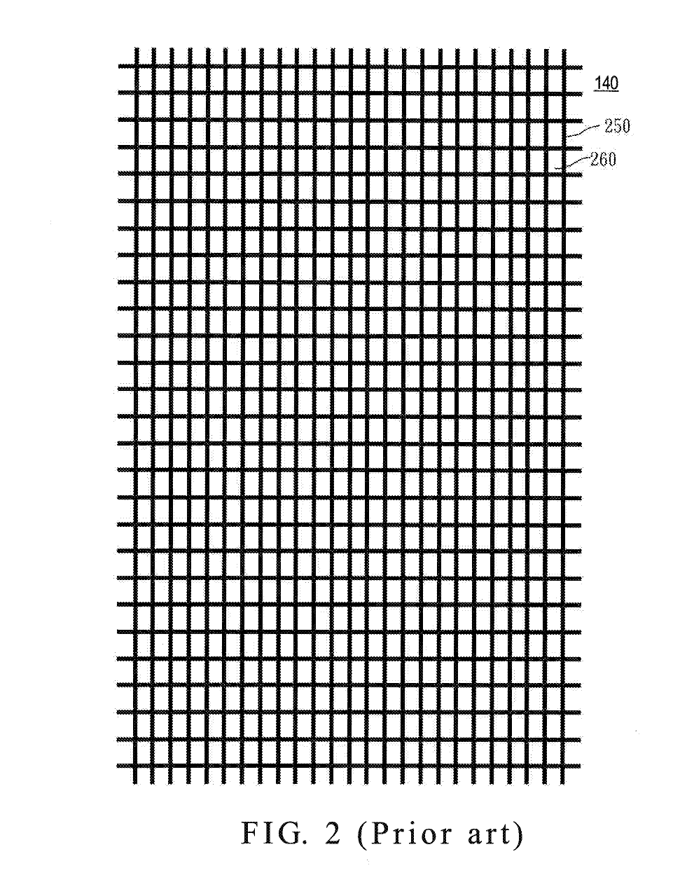

FIG. 2 shows a prior black matrix layer 140. As shown in FIG. 2, the prior black matrix layer 140 is composed of lines 250 of insulating material that are black and opaque. The lines 250 of black insulating material are arranged as a checkerboard pattern and a color filter 260 is disposed among the lines of black insulating material.

In the present invention, the sensing electrode layer 150 is arranged between the black matrix layer 140 and the color filter layer, and a touch sensing pattern structure is formed on the sensing electrode layer 150. Therefore, there is no need to dispose a sensing electrode layer (ITO) on the upper glass substrate or lower glass substrate of the LCD panel, thereby saving the manufacturing cost simplifying the assembly procedure, and further improving the panel yield.

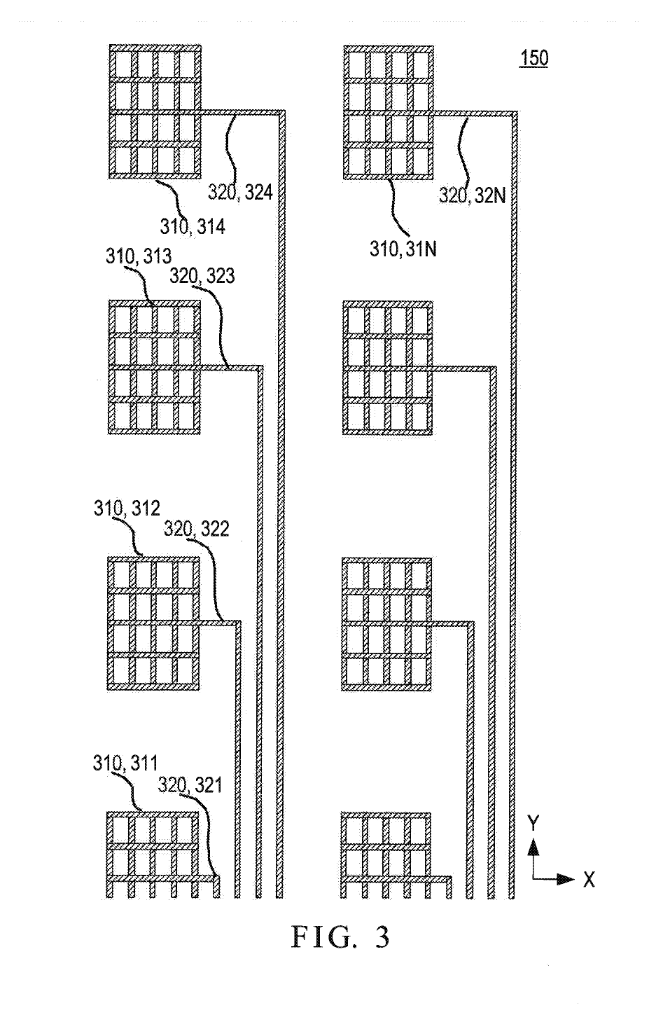

FIG. 3 is a schematic diagram of the sensing electrode layer 150 in accordance with the present invention. As shown in FIG. 3, the sensing electrode layer 150, that is disposed on one surface of the black matrix layer 140 facing the liquid crystal layer 130, is composed of a plurality of sensing conductive lines 310, 320. The plurality of sensing conductive lines 310, 320 are disposed at positions corresponding to the positions of the plurality of opaque lines 250 of the black matrix later 140.

As shown in FIG. 3, the plurality of sensing conductive lines 310, 320 of the sensing electrode layer 150 are arranged in a first direction (X-direction) and a second direction (Y-direction), wherein the first direction is vertical with the second direction. The plurality of sensing conductive lines 310, 320 of the sensing electrode layer 150 are made of conductive metal material or alloy material, wherein the conductive metal. material is selectively to be chromium, barium, and aluminum.

The plurality of sensing conductive lines 310, 320 are divided into a first group of sensing conductive lines 310 and a second group of sensing conductive lines 320. The first group of sensing conductive lines 310 is formed with N quadrilateral regions 311, 312, 313, . . . , 31N (311-31N), where N is a positive integer. The sensing conductive lines in any one of the quadrilateral regions are electrically connected together while the sensing conductive lines in any two quadrilateral regions are not electrically connected, so as to form a single-layered touch pattern on the sensing electrode layer 150.

Each of the quadrilateral regions 311-31N is formed in a rectangle, square, or rhombus shape. In this embodiment, each of the quadrilateral regions 311-31N is formed in a rectangle shape, and the plurality of sensing conductive lines 310 are disposed at positions corresponding to the positions of the plurality of opaque lines 250 of the black matrix later 140.

The second group of sensing conductive lines 320 is formed with N conductive traces 321, 322, 323, . . . , 32N (321-32N). Each of the N conductive traces 321-32N is electrically connected to a corresponding quadrilateral region 311-31N, while any two conductive traces 321-32N are not electrically connected.

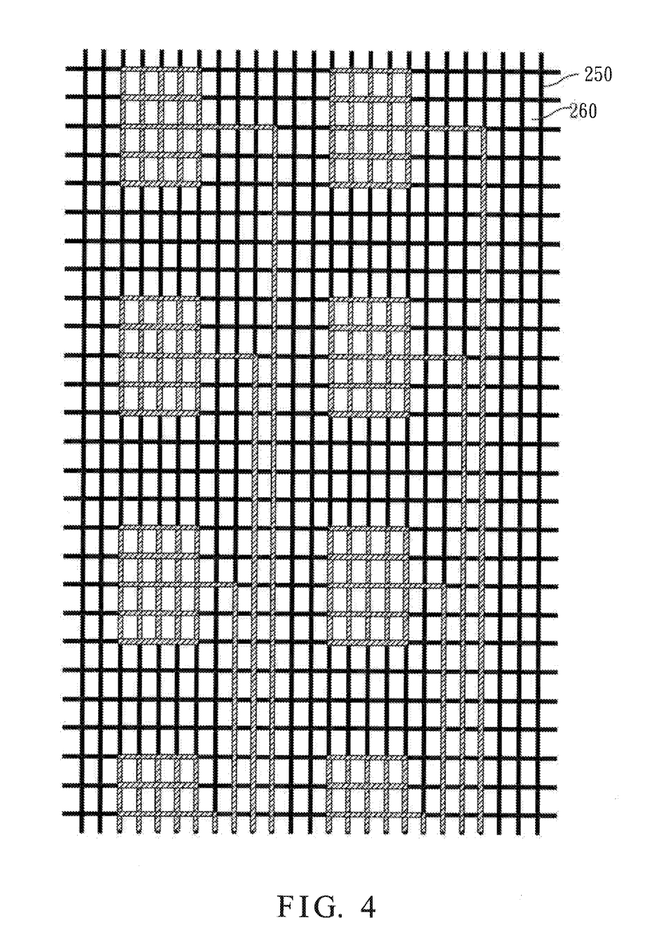

FIG. 4 is a schematic diagram of the black matrix layer 140 and the sensing electrode layer 150 in accordance with the present invention. As shown, it schematically illustrates the black matrix layer 140 overlapped with the sensing electrode layer 150, viewing from the liquid crystal layer 130 to the first substrate 110.

The first group of sensing conductive lines 310 is correspondingly connected to the second group of sensing conductive lines 320. That is, the N conductive traces 311-31N are respectively connected to the N conductive traces 321-32N. Therefore, the first group of sensing conductive lines 310 can form a single-layered touch pattern on the sensing electrode layer 150. The line width of the first group of conductive lines 310 or the second group of conductive lines 320 is preferred to be smaller than or equal to the line width of the plurality of the opaque lines 250. When viewing from the first substrate 110 to the liquid crystal layer 130, the first group of conductive lines 310 and the second group of conductive lines 320 can be concealed by the plurality of opaque lines 250, so that users only see the plurality of opaque lines 250 but not the first group of conductive lines 310 and the second group of conductive lines 320.

The color filter layer 160 is disposed among the plurality of sensing conductive lines 310, 320 of the sensing electrode layer 150 and on the surface of the plurality of sensing conductive lines 310, 320.

The over coating layer 170 is disposed on the surface of the color filter layer 160.

The common electrode layer 180 is disposed between the first substrate 110 and the second substrate 120. For VA and TN type LCD, the common electrode layer 180 is disposed on the first substrate 110. For IPS and FFS type LCD, the common electrode layer 180 is disposed on the second substrate 120.

The first polarizer layer 190 is disposed at one surface of the first substrate 110 opposite to the other surface of the first substrate 110 facing the liquid crystal layer 130.

The second polarizer layer 200 is disposed at one surface of the second substrate 120 opposite to the other surface of the second substrate 120 facing the liquid crystal layer 130.

The thin film transistor (TFT) layer 210 is disposed at the surface of the second substrate 120 facing the liquid crystal layer 130. The TFT layer 210 is composed of TFTs 212 and transparent electrodes 211.

In view of the foregoing, it is known that the present invention is capable of forming a single-layered touch pattern on the sensing electrode layer 150, which has the advantage of not requiring to arrange a sensing electrode layer on the upper glass substrate or lower glass substrate of the LCD panel, thereby lowering the cost and decreasing the number of manufacturing steps.

Although the present invention has been explained in relation to its preferred embodiment, it is to be understood that many other possible modifications and variations can be made without departing from the spirit and scope of the invention as hereinafter claimed.

What is claimed is:

1. An in-cell touch display panel structure with metal layer for sensing, comprising:
a first substrate;
a second substrate parallel to the first substrate;
a liquid crystal layer configured between the first substrate and the second substrates;
a black matrix layer disposed at one surface of the first substrate facing the liquid crystal layer, the black matrix layer being composed of a plurality of opaque lines; and
a sensing electrode layer disposed at one surface of the black matrix layer facing the liquid crystal layer, the sensing electrode layer being composed of a plurality of sensing conductive lines,
wherein the plurality of sensing conductive lines is disposed corresponding to positions of the plurality of opaque lines of the black matrix.

2. The in-cell touch display panel structure with metal layer for sensing as claimed in claim 1, wherein the plurality of sensing conductive lines are divided into a first group of sensing conductive lines and a second group of sensing conductive lines, the first group of sensing conductive lines being formed with N quadrilateral regions, where N is a positive integer, the sensing conductive lines in any one of the quadrilateral regions being electrically connected together while the sensing conductive lines in any two quadrilateral regions are not electrically connected, so as to form a single-layered touch pattern on the sensing electrode layer.

3. The in-cell touch display panel structure with metal layer for sensing as claimed in claim 2, the second group of sensing conductive lines is formed with N conductive traces, each of the N conductive traces being electrically connected to a corresponding quadrilateral region, while any two conductive traces are not electrically connected.

4. The in-cell touch display panel structure with metal layer for sensing as claimed in claim 3, wherein the plurality of sensing conductive lines of the sensing electrode layer are arranged in a first direction and a second direction.

5. The in-cell touch display panel structure with metal layer for sensing as claimed in claim 4, wherein the first direction is vertical with the second direction.

6. The in-cell touch display panel structure with metal layer for sensing as claimed in claim 5, further comprising a color filter layer that is disposed among the plurality of sensing conductive lines of the sensing electrode layer and on the surface of the plurality of sensing conductive lines.

7. The in-cell touch display panel structure with metal layer for sensing as claimed in claim 6, further comprising an over coating layer disposed on a surface of the color filter.

8. The in-cell touch display panel structure with metal layer for sensing as claimed in claim 7, further comprising a common electrode layer disposed between the first substrate and the second substrate.

9. The in-cell touch display panel structure with metal layer for sensing as claimed in claim 8, further comprising:
a thin film transistor (TFT) layer disposed at a surface of the second substrate facing the liquid crystal layer.

10. The in-cell touch display panel structure with metal layer for sensing as claimed in claim 9, wherein each of the quadrilateral regions is formed in a rectangle, square, or rhombus shape.

11. The in-cell touch display panel structure with metal layer for sensing as claimed in claim 10, wherein the plurality of sensing conductive lines of the sensing electrode layer are made of conductive metal material or alloy material.

12. The in-cell touch display panel structure with metal layer for sensing as claimed in claim 11, wherein the conductive metal material is selectively to be chromium, barium, and aluminum.
